(19) United States
(12) Patent Application Publication
(10) Pub. No.: US 2026/0343275 A1
(43) Pub. Date: Oct. 29, 2026

(54) TRANSITION DETECTION FOR COMMUNICATION CHANNEL SWITCHING

(71) Applicant: Capital One Services, LLC, McLean, VA (US)

(72) Inventors: Bryan TAMAYO, Allen, TX (US); Mark A. VANDERBROOK, Little Elm, TX (US)

(21) Appl. No.: 19/192,496

(22) Filed: Apr. 29, 2025

(51) Int. Cl. H04W 24/08; H04L 41/16

(52) U.S. Cl. CPC H04W 24/08; H04L 41/16

(57) ABSTRACT

In some implementations, a device may transmit, via a first communication channel associated with a user, one or more first messages. The device may determine, based on the one or more first messages, one or more interaction metrics for the first communication channel. The device may determine, based on the one or more interaction metrics, a transition score for the first communication channel, wherein the transition score is a predictive score that indicates a likelihood that the user will transition from use of the first communication channel. The device may perform an action based on the transition score satisfying a transition threshold.

### BACKGROUND

In some examples, a system may use multiple communication channels for communicating with one or more devices. The system may need to ensure message consistency and branding across channels, perform resource allocation for diverse usage patterns, integrate data from disparate sources, ensure compliance with stringent privacy regulations, and/or meet rapid response time expectations, among other examples. In some examples, the system may transmit messages via one or more ineffective communication channels, resulting in increased operational costs, strained infrastructure, and/or wasted resources (e.g., processing resources, network resources, and/or power resources).

### SUMMARY

Some implementations described herein relate to a system for using an artificial intelligence or machine learning (AI/ML) model to detect transitions for communication channel switching. The system may include one or more memories and one or more processors communicatively coupled to the one or more memories. The one or more processors may be configured to transmit, via a first communication channel associated with a user, one or more first messages. The one or more processors may be configured to determine, based on the one or more first messages, one or more interaction metrics for the first communication channel. The one or more processors may be configured to determine, using the AI/ML model and based on the one or more interaction metrics, a transition score for the first communication channel, wherein the transition score is a predictive score that indicates a likelihood that the user will transition from use of the first communication channel. The one or more processors may be configured to obtain one or more second messages to be transmitted via the first communication channel. The one or more processors may be configured to route, based on the transition score satisfying a transition threshold, the one or more second messages to a second communication channel. The one or more processors may be configured to transmit, based the one or more second messages being routed to the second communication channel, the one or more second messages via the second communication channel.

Some implementations described herein relate to a method for transition detections for communication channel switching. The method may include transmitting, by a device and via a first communication channel associated with a user, one or more first messages. The method may include determining, by the device and based on the one or more first messages, one or more interaction metrics for the first communication channel. The method may include determining, by the device and based on the one or more interaction metrics, a transition score for the first communication channel, wherein the transition score is a predictive score that indicates a likelihood that the user will transition from use of the first communication channel. The method may include performing, by the device, an action based on the transition score satisfying a transition threshold.

Some implementations described herein relate to a non-transitory computer-readable medium that stores a set of instructions. The set of instructions, when executed by one or more processors of a device, may cause the device to transmit, via a first communication channel associated with a user, one or more first messages. The set of instructions, when executed by one or more processors of the device, may cause the device to determine, using an artificial intelligence or machine learning (AI/ML) model and based on one or more interaction metrics for the first communication channel, a transition score for the first communication channel, wherein the transition score is a predictive score that indicates a likelihood that the user will transition from use of the first communication channel. The set of instructions, when executed by one or more processors of the device, may cause the device to obtain one or more second messages to be transmitted via the first communication channel. The set of instructions, when executed by one or more processors of the device, may cause the device to route, based on the transition score satisfying a transition threshold, the one or more second messages to a second communication channel. The set of instructions, when executed by one or more processors of the device, may cause the device to transmit, based the one or more second messages being routed to the second communication channel, the one or more second messages via the second communication channel.

### BRIEF DESCRIPTION OF THE DRAWINGS

FIGS. 1A-1C are diagrams of an example associated with transition detection for communication channel switching, in accordance with some embodiments of the present disclosure.

FIG. 2 is a diagram illustrating an example of training and using a machine learning model in connection with transition detection for communication channel switching, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with transition detection for communication channel switching, in accordance with some embodiments of the present disclosure.

FIG. 5 is a flowchart of an example process associated with transition detection for communication channel switching, in accordance with some embodiments of the present disclosure.

### DETAILED DESCRIPTION

The following detailed description of example implementations refers to the accompanying drawings. The same reference numbers in different drawings may identify the same or similar elements.

A system may utilize multiple communication channels for transmitting messages. For example, the multiple communication channels may include one or more phone (or audio) channels (e.g., each associated with a respective phone number), one or more email channels (e.g., each associated with a respective email address), one or more short messaging service (SMS) (or text message) channels, an application channel (e.g., a push notification or pop-up message channel), a physical mail channel, and/or another type of communication channel. In some examples, the system may utilize separate or distinct pipelines, systems, system flows, and/or protocols for each communication channel. For example, the system may manage communication channels separately because of the different channel-specific features, different technical requirements, different regulatory and/or compliance rules, redundancy and reliability concerns (e.g., managing communication channels separately may allow for greater control over redundancy strategies for critical communication channels), and/or enhanced performance optimization (e.g., by managing communication channels separately, the system can optimize performance for each communication channel individually), among other examples.

In some examples, a user may transition from using a first communication channel to using a second communication channel. For example, the user may switch email addresses, may switch phone numbers, and/or may discontinue use of a given communication channel (e.g., of a given email address or a given phone number), among other examples. In such examples, the system may not obtain an indication or notification of the transition in the communication channel. As a result, the system may continue to transmit one or more messages via the first communication channel. This may consume network resources, processing resources, and/or memory resources, among other examples, associated with the system transmitting the one or more messages via the first communication channel which is no longer being used by the user.

In some examples, the system may detect that the user has transitioned from using a given communication channel (e.g., has stopped using the communication channel). However, techniques for detecting the transition may be reactive techniques in that the detection occurs after the user has transitioned from using the given communication channel. For example, the system may perform bounce-back detection, where the system monitors for delivery failures or non-delivery reports associated with the communication channel. A bounce indicates that the communication channel is no longer valid, signaling a transition away from the communication channel. As another example, the system may track open rates, read rates, or other engagement information to identify if the user is engaging with messages sent via the communication channel. However, these techniques for detecting the transition may involve the system transmitting one or more messages via the communication channel after the user has transitioned away from using the communication channel. For example, the system may use information obtained from the transmission of the one or more messages via the communication channel (e.g., that are transmitted after the use has transitioned away from using the communication channel) to detect the transition away from the communication channel. As a result, the system may consume network resources, processing resources, and/or memory resources, among other examples, associated with the system transmitting the one or more messages via the communication channel (e.g., that are transmitted after the use has transitioned away from using the communication channel) to enable the detection of the transition away from the communication channel.

Additionally, vast amounts of data may be stored electronically in data structures (e.g., databases, blockchains, log files, cookies, or the like) for messages sent via different communication channels by the system. The system may perform multiple queries, or other information retrieval techniques, to unrelated data structures to obtain data relevant to monitoring or managing multiple communication channels for a user. Moreover, each data structure may employ a particular schema and/or use particular data formatting conventions for data storage. Thus, the data may be incompatible and difficult to integrate into machine-usable outputs for computational instructions or automation. This incompatibility may necessitate separate handling of the data using complex instructions and/or repetitive processing to monitor or manage multiple communication channels for a user, thereby expending significant computing resources (e.g., processor resources and/or memory resources) and causing significant delays.

Further, separate use of the data, such as individually presenting the data in a user interface for analysis (such as for presentation to an analyst responsible for managing the messaging to the user), may be inefficient. For example, the system may separately process and/or reformat data from different data structures to obtain information for presenting in the user interface, thereby expending significant computing resources. Additionally, individually presenting the data may increase the size of a user interface or utilize multiple user interfaces to enable the analyst to view and/or access relevant data for managing the messaging to the user. Navigating through a large user interface or a large number of user interfaces to find relevant information creates a poor user experience, consumes excessive computing resources that are needed for a device to generate and display the user interface(s) and that are needed for one or more devices to serve the user interface(s) to the device, and consumes excessive network resources that are needed for communications between the devices.

Some implementations described herein enable transition detection for communication channel switching. In some examples, a communication manager may detect a transition away from a communication channel using a proactive approach. For example, the communication manager may transmit, via a first communication channel associated with a user, one or more messages. The communication manager may determine, based on the one or more first messages, one or more interaction metrics for the first communication channel. An interaction metric may be a measure of interaction by the user with the one or more messages transmitted via the first communication channel. The communication manager may determine, based on the one or more interaction metrics, a transition score for the first communication channel. The transition score may be a predictive score that indicates a likelihood that the user will transition away from use of the first communication channel. In some examples, the communication manager may obtain the transition score via an artificial intelligence (AI) and/or machine learning (ML) (AI/ML) model. For example, the communication manager may provide the one or more interaction metrics to the AI/ML model as input. The communication manager may obtain, from the AI/ML model, an output that indicates the transition score.

The communication manager may obtain one or more messages to be transmitted via the first communication channel. The communication manager may determine whether to transmit the one or more messages via the first communication channel or a second communication channel based on the transition score. For example, the communication manager may route, based on the transition score satisfying a transition threshold, the one or more messages to the second communication channel. The communication manager may transmit, based on the one or more messages being routed to the second communication channel, the one or more messages via the second communication channel. In some examples, the communication manager may transmit the one or more messages via the first communication channel in addition to transmitting the one or more messages via the second communication channel.

As a result, the communication manager can proactively detect when a user is likely to transition away from use of the first communication channel and can proactively perform one or more operations to switch communication channels (e.g., to the second communication channel). For example, by the communication manager determining the transition score using the one or more interaction metrics, the communication manager may obtain a predictive measure of the likelihood that the user will transition away from the first communication channel in the future. This enables the communication manager to obtain one or more messages to be transmitted to the first communication channel, route the one or more messages to the second communication channel based on the transition score satisfying the transition threshold, and transmit the one or more messages via the second communication channel, thereby enabling the communication manager to preemptively switch communication channels (e.g., before the user has actually transitioned away from using the first communication channel) using the predictive transition score. As a result, the communication manager may conserve network resources, processing resources, and/or memory resources, among other examples, that would have otherwise been associated with the communication manager transmitting the one or more messages via the first communication channel which the user is likely transitioning away from using. Additionally, the communication manager may conserve network resources, processing resources, and/or memory resources, among other examples, that would have otherwise been associated with transmitting one or more messages via the first communication channel after the user has transitioned away from using the first communication channel to enable the communication manager to detect the transition away from the first communication channel.

Additionally, by the communication manager using an AI/ML model to determine the transition score, the communication manager may conserve resources, reduce complexity, and/or improve the accuracy of the detection of the transition away from the first communication channel. For example, the AI/ML model may enable the communication manager to perform operations based on otherwise incompatible data (e.g., the one or more interaction metrics and/or other information associated with transmission of messages via the first communication channel) while conserving computing resources and reducing delays that would otherwise result from separate handling of the data using complex instructions and/or repetitive processing. Moreover, an output of the AI/ML model may convey data (e.g., the transition score) from the multiple unrelated databases in a smaller size than otherwise would have been used to individually present data from the multiple unrelated databases. In this way, the use of computing resources and network resources is reduced in connection with serving, generating, and/or displaying the data.

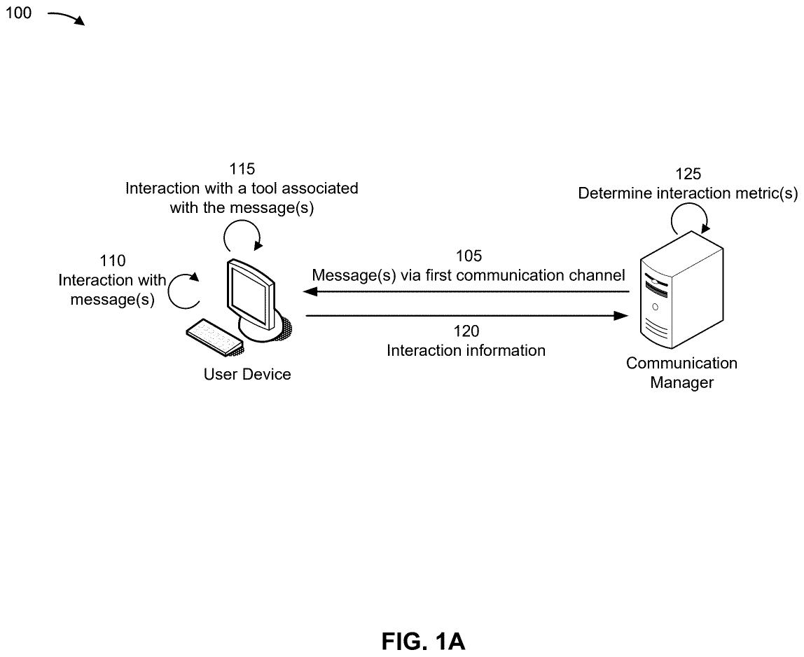

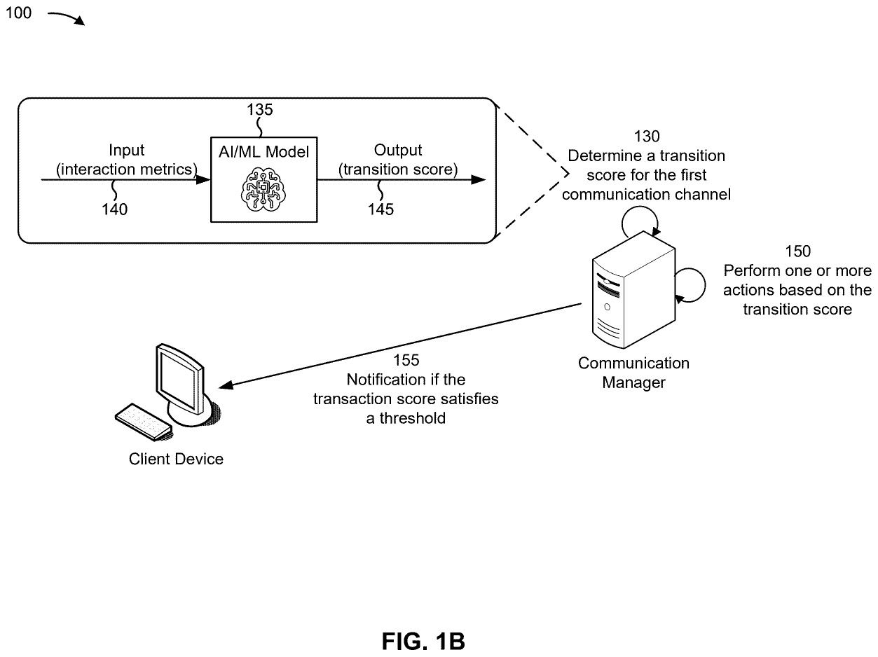

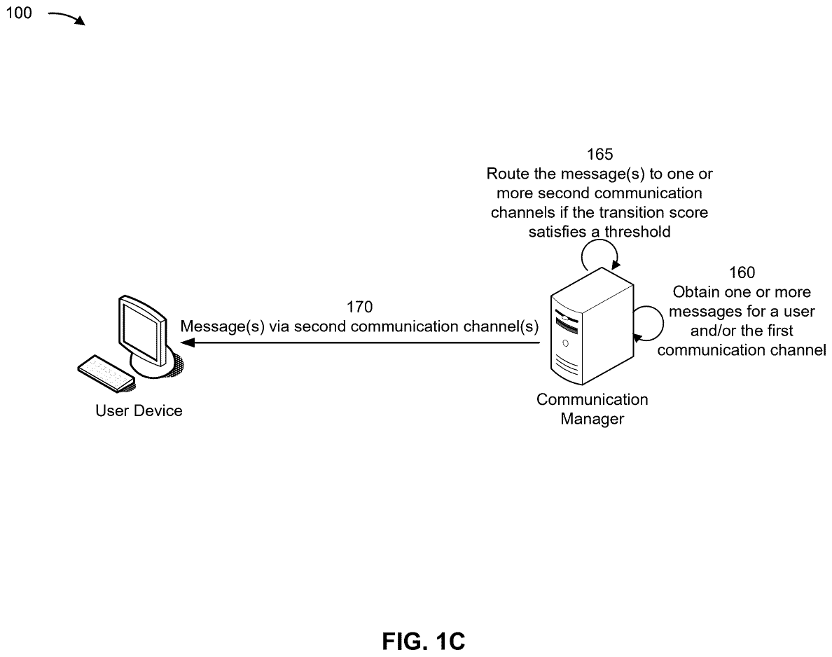

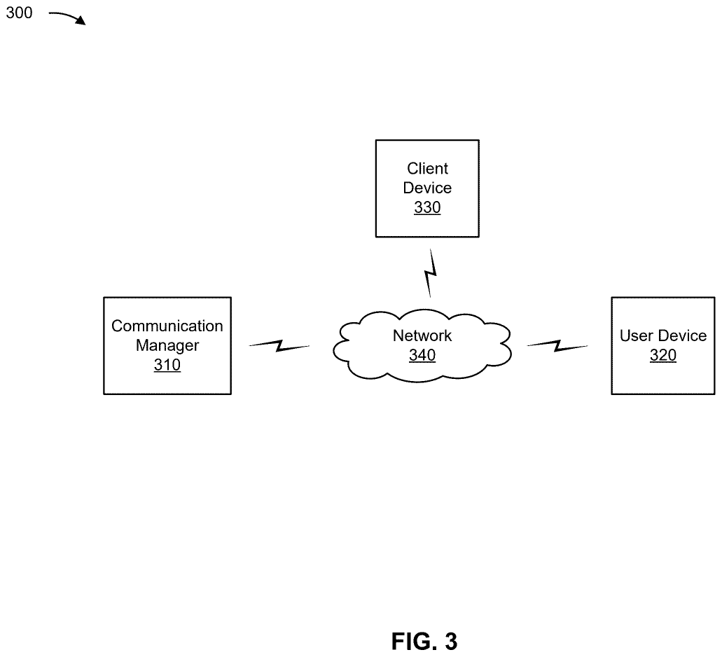

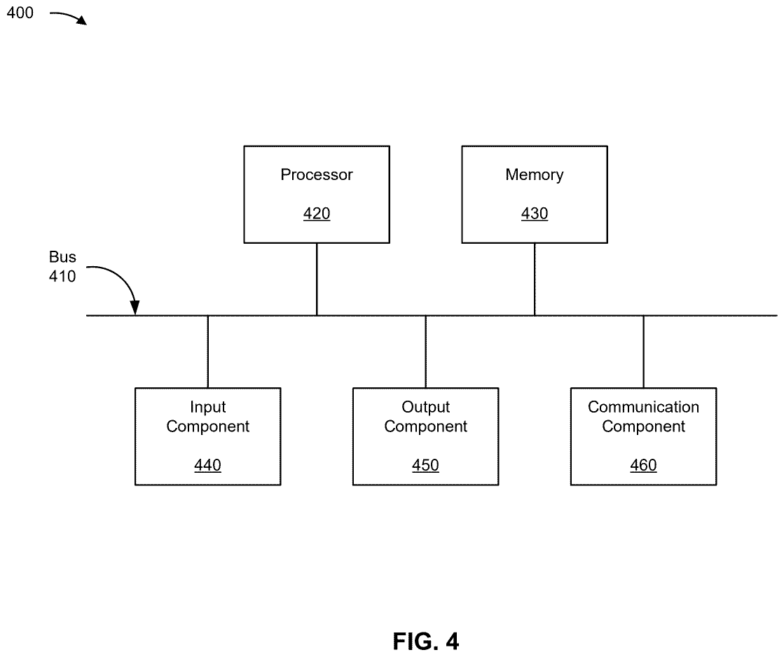

FIGS. 1A-1C are diagrams of an example 100 associated with transition detection for communication channel switching. As shown in FIGS. 1A-1C, example 100 includes a communication manager, a user device, and a client device. These devices are described in more detail in connection with FIGS. 3 and 4.

The communication manager may be configured to manage communications over multiple communication channels. For example, the communication manager may be associated with a tool or system for which messages are transmitted via the multiple communication channels. As used herein, “communication channel” refers to a medium or pathway through which information or messages are transmitted between devices or systems. For example, a communication channel may include a phone or audio channel (e.g., associated with a given phone number), an email channel (e.g., associated with a given email address), an SMS or text message channel (e.g., associated with a given phone number), an application channel (e.g., a push notification or pop-up message channel), a physical mail channel, and/or another type of communication channel.

As shown in FIG. 1A, and by reference number 105, the communication manager may transmit, and the user device may receive, one or more messages via a first communication channel. In some examples, the communication manager may cause another device or system to transmit the one or more messages via a first communication channel. The first communication channel may be associated with a first address or identifier, such as an email address, phone number, or username, among other examples. For example, the communication manager may transmit the one or more messages to a first email address (e.g., the one or more messages may be email messages directed to the first email address). In other examples, the communication manager may transmit the one or more messages to a first phone number (e.g., the one or more messages may be SMS messages or phone calls directed to the first phone number and the first communication channel may be an SMS channel or a phone channel). In other examples, the first communication channel may be another type of communication channel.

As shown by reference number 110, the user device may obtain one or more interactions with the one or more messages. For example, a user may interact with the user device to read, open, inspect, and/or otherwise interact with the one or more messages. In some examples, the user device may track the one or more interactions via an application executing on the user device (e.g., an email application, a messaging application, an SMS application, or another type of application), via a client hosted by the user device (e.g., an email client), and/or via an operating system of the user device. For example, for email messages, the user device may track interactions using an email client or an email application. The email client or the email application may log a sender, a recipient, a timestamp, subject, a message status (e.g., read, opened, unopened, replied, or deleted), a delivery status (e.g., via a transmission protocol, such as an Internet message access protocol (IMAP) or a simple mail transfer protocol (SMTP)), a read receipt indication, and/or a deliver notification indication, among other examples.

As another example, for phone calls, the user device may track the one or more interactions via the operating system of the user device. For example, the operating system may log information associated with phone calls received by the user device. The logged information may include a phone number (e.g., from which a phone call is received), a call duration, a timestamp, a call status (e.g., incoming, outgoing, missed, declined, or another status), among other examples. For text or SMS messages, the user device may track the one or more interactions via message metadata stored by a messaging application. The message metadata may include a sender phone number or identifier (e.g., a username or session identifier), a recipient phone number or identifier (e.g., username), a message content, a timestamp, message status (e.g., read, opened, unopened, replied, or deleted), a delivery status, a read receipt indication, and/or a deliver notification indication, among other examples.

In some examples, the one or more interactions may include opening a message (e.g., via an application or client executing on the user device), reading a message (e.g., as indicated by an amount of time that a message is open via a display of the user device and/or user interactions (e.g., clicks, touch gestures, or other interactions) with the message displayed by the user device), accepting a message (e.g., opening a message or answering a phone call), and/or deleting a message, among other examples. In some examples, the user may not interact with a message. For example, the user may not open, read, inspect, and/or otherwise interact with the message. In such examples, the user device may receive or obtain a message and may detect or determine that there are no interactions with the message.

In some examples, as shown by reference number 115, the user device may obtain one or more interactions with a tool that is associated with the one or more messages. For example, as described elsewhere herein, the communication manager may be configured to transmit messages for the tool. As an example, the tool may be a service tool configured to provide a service. For example, the tool may be a vehicle service tool that enables consumers to research vehicles, finance vehicles, purchase vehicles, and/or to connect with vehicle dealers, among other examples. In such examples, the one or more messages may be messages to a vehicle dealer, where the one or more messages are associated with the vehicle service tool. In other examples, the tool may be associated with another service or purpose.

The one or more interactions with the tool may include the user opening or launching the tool via the user device, performing one or more actions via the tools, navigating through one or more pages or user interfaces provided by the tool, and/or interacting with a page or user interface provided by the tool, among other examples. In some examples, the user device may log or track the one or more interactions with the tool. For example, the user device may log or track each time the tool is used, activated, and/or launched, among other examples. As another example, the user device may log or track a duration of use of the tool (e.g., for each instance of the tool being used, activated, and/or launched). In some examples, the user device may log or track an available time for the tool to be used, such as a total time the tool is available during a shift, a day, or an operation period, among other examples. This available time may account for any downtime of the tool, such as for maintenance, or when other times when the tool is not available use.

As shown by reference number 120, the user device may transmit, and the communication manager may receive, interaction information for the one or more messages (e.g., that were transmitted as depicted and described in connection with reference number 105). The interaction information may indicate the one or more interactions (or lack thereof) with the one or more messages (e.g., as described in connection with reference number 110) and/or the one or more interactions with the tool (e.g., as described in connection with reference number 115). Additionally, or alternatively, the communication manager may receive the interaction information from another device, such as a server device (not shown in FIGS. 1A-1C). For example, the communication manager may receive the interaction information from a server device that is configured to manage or serve the first communication channel. For example, the server device may be an email server device (e.g., if the first communication channel is an email channel), a messaging server device (e.g., if the first communication channel is an SMS or text message channel), or another server device configured to manage or serve the first communication channel. Additionally, or alternatively, the server device may be configured to manage or serve the tool.

As shown by reference number 125, the communication manager may determine one or more interaction metrics based on the interaction information. The one or more interaction metrics may be for the first communication channel. The one or more interaction metrics may indicate an interaction level of the user with the one or more messages via the first communication channel. For example, the one or more interaction metrics may include an open rate (e.g., indicating a percentage of messages opened by the user), a click-through rate (e.g., indicating a percentage of messages in which the user clicked on (or interacted with) a link or a call-to-action included in a message), a response rate (e.g., indicating a percentage of messages responded to by the user), and/or a failure indication rate (e.g., indicating a percentage of messages which were unable to be delivered), among other examples.

For example, the one or more messages may include one or more tracking pixels. A tracking pixel may be an image (e.g., of a size of a single pixel) embedded in the content of a message. The image may be associated with an identifier (e.g., a uniform resource locator (URL)) that is unique to the message. When a message is opened, a client (e.g., an email client or a messaging client on the user device) may transmit a request for the image (e.g., the client may request the image from a server device that hosts the image). The server device may log the request for the image. Because the identifier of the image is unique to the message, the request for the image may indicate that the message was opened by the user device. For example, the interaction information may indicate the request for the image. The communication manager may determine an open rate for the one or more messages based on a number of messages for which images (e.g., for tracking pixels) were requested.

As another example, the one or more messages may include one or more tracking links (e.g., URL identifiers or URL links). For example, a message may include a URL (such as to a website, product, page, or other resource). The URL may include a tracking parameter or identifier that is unique to the message and/or the user. If the user interacts with (e.g., clicks or selects) the URL, a server device or the communication manager may log the interaction by identifying or capturing the tracking parameter or identifier in the URL. This enables the server device or the communication manager to determine which user interacted with the URL. For example, the interaction information may indicate one or more interactions with one or more URLs that include a tracking parameter or identifier that is unique to the user. This enables the communication manager to determine a click-through rate for the one or more messages (e.g., based on how many of the message(s) included tracking URLs and how many of the tracking URLs were interacted with by the user via the user device).

In some examples, the one or more interaction metrics may include one or more soft bounce tracking metrics. Soft bounce tracking may refer to the communication manager tracking when a message is temporarily undeliverable (e.g., but may be later deliverable). For example, a message may be temporarily undeliverable due to a full inbox, a server issue, and/or another transient issue. For example, when the communication manager transmits a message, the communication manager may transmit the message to a service provider for a given communication channel (e.g., for the first communication channel), such as an email service provider for an email channel. The service provider may attempt to deliver the message to the address indicated by the message (e.g., to a recipient message server). If the recipient message server cannot deliver the message, the recipient message server may provide a bounce notification to the communication manager (e.g., the interaction information may include any bounce notifications for the one or more messages). The bounce notification may be transmitted in accordance with the SMTP protocol.

In some examples, the bounce notification may include a code or reason explaining the delivery failure. The communication manager may determine the one or more soft bounce tracking metrics based on the code or reason explaining the delivery failure. For example, the code or reason explaining the delivery failure may indicate a full inbox, a sever unavailability, a message size being too large, and/or the recipient message server rejecting the message, among other examples. The communication manager may determine a soft bounce rate associated with the one or more messages (e.g., indicating a percentage of messages associated with a soft bounce as indicated by the code or reason explaining the delivery failure of a given message). For example, the failure indication rate may indicate or include the soft bounce rate.

Additionally, or alternatively, the one or more interaction metrics may include one or more hard bounce tracking metrics. Hard bounce tracking may refer to the communication manager tracking when a message is undeliverable due to a permanent failure or issue. For example, the bounce notification may indicate a code or reason that is indicative of a permanent failure or issue. For example, a hard bounce code or reason may indicate that a message was undeliverable due to an invalid address (e.g., an invalid email address), a nonexistent domain (e.g., a nonexistent domain address for an indicated email address), a nonexistent address (e.g., indicating that an email address is no longer in use due to being deleted, disabled, or closed), and/or a blocked address, among other examples. The one or more interaction metrics may include a hard bounce metric (e.g., indicating if a message is associated with a hard bounce). For example, the failure indication rate may indicate or include the hard bounce metric.

In some examples, the communication manager may obtain the one or more soft bounce tracking metrics and/or the one or more soft bounce tracking metrics based on an event. For example, the event may include a value of another interaction metric not satisfying a threshold. For example, if an open rate or a click-through rate for the one or more messages, the communication manager may obtain the one or more soft bounce tracking metrics and/or the one or more soft bounce tracking metrics. Additionally, or alternatively, the communication manager may obtain the one or more soft bounce tracking metrics and/or the one or more soft bounce tracking metrics periodically (e.g., based on a periodic schedule).

The communication manager may obtain the one or more soft bounce tracking metrics and/or the one or more soft bounce tracking metrics by transmitting a request to a server device associated with the first communication channel. For example, if the first communication channel is an email channel, the communication manager may transmit a request to an email server to confirm that the domain for the first communication channel exists and to verify that the domain and email address for the first communication channel are accurate and/or valid. For example, the request may cause the server device to provide the bounce notification described elsewhere herein. In some examples, the communication manager may obtain the one or more soft bounce tracking metrics and/or the one or more soft bounce tracking metrics by performing a mail exchange (MX) lookup operation, an SMTP validation operation, and/or a domain validation operation to detect invalid email addresses.

In some implementations, the one or more interaction metrics may include a utilization rate, associated with the user, for the tool. For example, as described in connection with reference number 115, the one or more messages may be associated with the tool. The interaction information may be associated with one or more interactions associated with the tool. For example, the communication manager may determine a utilization rate based on a quantity of instances that the tool was used and a quantity of instances that the tool could have been used (e.g., the utilization rate may be the quantity of instances that the tool was used divided by the quantity of instances that the tool could have been used). Additionally, or alternatively, the communication manager may determine a utilization rate based on an amount of time that the tool was used and an available time for which the tool was available for use (e.g., the utilization rate may be the amount of time that the tool was used divided by the available time for which the tool was available for use).

As shown in FIG. 1B, and by reference number 130, the communication manager may determine a transition score for the first communication channel. The communication manager may determine the transition score based on the one or more interaction metrics. The transition score may be a predictive score that indicates a likelihood that the user will transition from use of the first communication channel (e.g., in the near future). For example, the communication manager may track the one or more interaction metrics for the first communication channel over time. The communication manager may determine a trend or pattern in the one or more interaction metrics that is indicative of the user transitioning away from using the first communication channel.

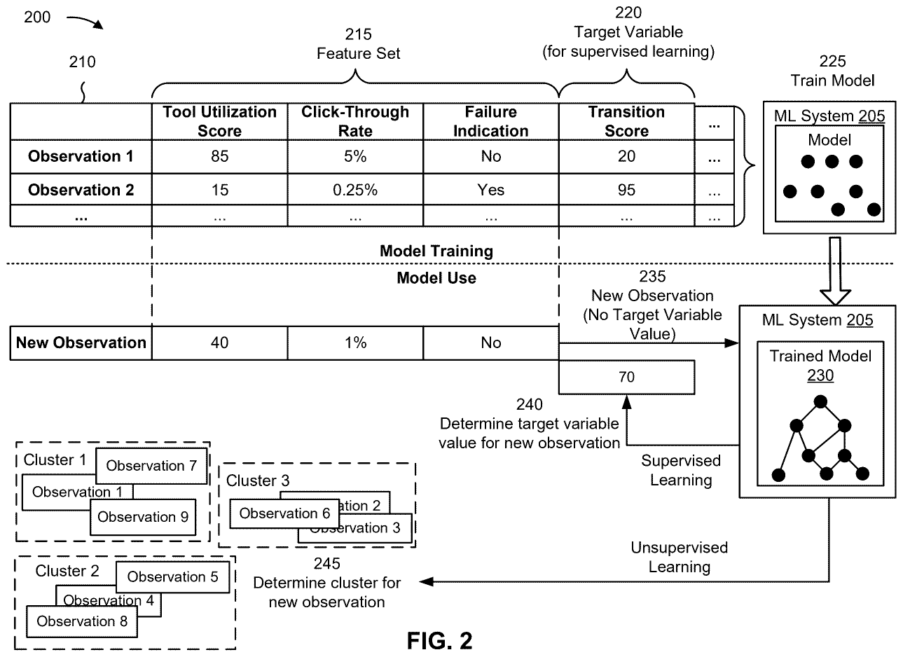

In some examples, the communication manager may use an AI/ML model 135 to determine the transition score. In some examples, the AI/ML model 135 may be a linear regression model (e.g., associated with high computational efficiency), a logistic regression model, a decision tree model (e.g., providing a flexible and interpretable model for determining the transition score), a random forest model (e.g., providing improved accuracy and generalization for determining the transition score), a support vector machine (SVM) model, a neural network model (e.g., providing improved effectiveness and accuracy for complex datasets), or a deep learning model, among other examples. The use and/or training of the AI/ML model 135 is depicted and described in more detail in connection with FIG. 2.

For example, the communication manager may determine, using the AI/ML model 135 and based on the one or more interaction metrics, the transition score for the first communication channel. For example, as shown by reference number 140, the communication manager may provide, to the AI/ML model 135, an input indicating the one or more interaction metrics. As shown by reference number 145, the communication manager may obtain, from the AI/ML model 135, an output indicating the transition score. For example, the output may be based on, in response to, or otherwise associated with, the input.

By the communication manager using the AI/ML model 135 to determine the transition score, the communication manager may be enabled to leverage large datasets of interaction information and/or interaction metrics for different communication channels to identify complex patterns and relationships in the data, which may be beyond human capability. This enables the communication manager to improve the accuracy of the predictive transition score. Additionally, by the communication manager using the AI/ML model 135 to determine the transition score, the communication manager may process of real-time interaction information and/or interaction metrics, generating transition scores for a communication channel that may adapt to changes over time without manual intervention, which may improve efficiency. Further, by the communication manager using the AI/ML model 135 to determine the transition score, the communication manager may process a wide variety of data types (e.g., including structured, unstructured, and/or high-dimensional data) enabling predictions across different domains or communication channel types. For example, different communication channels may be associated with interaction information in different formats, different datasets, and/or different schema, among other examples. The AI/ML model 135 enables the communication manager to process the interaction information for multiple communication channels. Additionally, by the communication manager using the AI/ML model 135 to determine the transition score, the communication manager may obtain a transition score that is based on to individual cases associated with historical data and patterns, such as historical data or patterns specific to the user for which the one or more messages were transmitted.

As shown by reference number 150, the communication manager may perform one or more actions based on the transition score. For example, the communication manager may perform the one or more actions based on the transition score satisfying a transition threshold. The transition score satisfying the transition threshold may indicate that the user is likely transitioning away from using the first communication channel. In some examples, the communication manager may perform the one or more actions based on a rate of change of the transition score satisfying a rate threshold (e.g., the transition score satisfying the transition threshold may include, or be based on, transition score satisfying a transition threshold). For example, if the transition score for the first communication channel and the user is changing rapidly (e.g., as indicated by the rate of change of the transition score satisfying the rate threshold), then this may indicate that the user is likely transitioning away from using the first communication channel.

In some examples, as shown by reference number 155, the one or more actions may include the communication manager transmitting, to a client device, a notification based on the transition score satisfying the transition threshold. For example, the communication manager may transmit, via a communication channel, a notification indicating that the user is transitioning from use of the first communication channel based on the transition score satisfying the transition threshold. The communication channel may be an internal communication channel or a representative communication channel. For example, the notification may be provided to a representative or a system that is associated with the tool (e.g., the tool described in connection with FIG. 1A). By the communication manager providing the notification indicating that the user is transitioning from use of the first communication channel, a representative associated with the tool may be enabled to contact the user (and/or an organization associated with the user) to determine if the user is actually transitioning from use of the first communication channel and/or to obtain information (e.g., a personal email address or a personal phone number) for a second communication channel that should be used instead of the first communication channel. By the communication manager providing the notification indicating that the user is transitioning from use of the first communication channel, the representative may obtain such information prior to the user actually discontinuing use of the first communication channel and/or prior to the user leaving the organization associated with the user. This improves the likelihood that the information for the second communication channel can be successfully obtained (e.g., if not already stored by the communication manager).

As shown in FIG. 1C, the one or more actions may include the communication manager transitioning from using a first communication channel to using a second communication channel. In some examples, the first communication channel and the second communication may be the same type of communication channel (e.g., an email channel, a phone channel, or another type of channel) for different addresses (e.g., different email addresses or different phone numbers). For example, the first communication channel may be associated with a work email address (e.g., using a domain address for an organization associated with the user) of the user and the second communication channel may be associated with a personal email address of the user.

For example, the communication manager may perform the one or more actions to transition the user from using the first communication channel to using the second communication channel. In some examples, the communication manager may store different communication channels (e.g., different email addresses, different phone numbers, and/or different messaging platform addresses) available for use to contact the user. The different communication channels may be stored by the communication manager with tokenized identifiers to maintain continuity as a user changes organizations that the user may be associated with.

For example, the first communication channel may be associated with a first organization (e.g., the first communication channel may be associated with an email address that includes a domain address that is associated with the first organization). The transition score satisfying the transition threshold may indicate that the user is transitioning away from an association with the first organization (e.g., transitioning away from employment with the first organization). In some examples, the first communication channel may associated with an email account (e.g., identified by an email address). The email account is associated with the first organization. In some examples, the tool may be associated with the first organization (e.g., the tool may be provided for, or managed by, the first organization). In such examples, the transition score may indicates a likelihood that the user is transitioning away from an association with the first organization. For example, the combination of the interaction metrics for the one or more messages and the interaction metrics (e.g., the utilization rate) for the tool may be indicative of whether the user is transitioning away from an association with the first organization (e.g., because the tool may be used as a part of an operation or job performed by the user for the first organization).

In some examples, the communication manager may determine or select the second communication channel. The communication manager may determine, based on the transition score satisfying the transition threshold, the second communication channel based on the transition score. The communication manager may use different communication channels (personal email, text message, phone call, or a combination of communication channels) based on the value of the transition score. For example, if the transition score indicates a lower likelihood of transition, then the communication manager may transition to transmitting via a text or SMS communication channel (e.g., because text or SMS messages may be less intrusive for the user). As another example, if the transition score indicates a higher likelihood of transition, then the communication manager may transmit an email to a second email address (e.g., a personal email address) of the user (e.g., as the user likely is transitioning from using of a first email address associated with the first communication channel).

In some implementations, the communication manager may select the second communication channel based on a rate of change of the transition score. For example, if the rate of change indicates a rapid decrease in interaction via the first communication channel, then the communication manager may select a personal email address (or a combination of a personal email address and a personal phone number for an SMS text message) to be the second communication channel. This enables the communication manager to adapt which communication channel the user is transitioned to depending on how rapidly the transition score is changing over time. As a result, the communication manager may improve the likelihood that the user receives message(s) intended for the user by using real-time changes in the transition score.

As shown by reference number 160, the communication manager may obtain one or more messages for the user and/or for the first communication channel. For example, the one or more messages may be generated by the communication manager or provided to the communication manager. The one or more messages may be intended for the user. In some examples, the first communication channel may be active when the one or more messages are obtained by the communication manager. In other words, the communication manager may be able to transmit the one or more messages via the first communication channel (e.g., a domain address or email address for the first communication channel may still be valid or active).

As shown by reference number 165, the communication manager may route, based on the transition score satisfying the transition threshold, the one or more messages to the second communication channel. For example, the communication manager may modify recipient information for the one or more messages based on the transition score satisfying the transition threshold. For example, the communication manager may modify a recipient address (e.g., email address) from a first email address (e.g., associated with the first communication channel) to a second email address (e.g., associated with a second communication channel). As another example, the communication manager may modify a recipient phone number from a first phone number (e.g., associated with the first communication channel) to a second phone number (e.g., associated with a second communication channel).

In some examples, the communication manager may modify a format or structure of the one or more messages to transmit the one or more messages via a different type of communication channel. For example, the communication manager may extract content from the one or more messages. The communication manager may identify a template format for messages associated with the second communication channel. The communication manager may insert the content into a content field of the template format. This enables the communication manager to transmit the content included in the one or more messages via a different format or structure that is associated with the second communication channel. For example, the first communication channel may be an email communication channel and the second communication channel may be an SMS communication channel. The communication manager may extract content from an email message and insert the content into a body of an SMS message (e.g., using an SMS template format).

As shown by reference number 170, the communication manager may transmit, and a user device (e.g., the user device depicted in FIG. 1A or a different user device) may receive, the one or more messages via the second communication channel. For example, the communication manager may transmit, based the one or more second messages being routed to the second communication channel, the one or more second messages via the second communication channel.

In some implementations, the one or more actions may include the communication manager refraining from transmission of messages for the user via the first communication channel based on the transition score satisfying the transition threshold. This may conserve network resources, processing resources, and/or other resources that would have otherwise been used by the communication manager transmitting the one or more messages via a communication channel that the user is likely transitioning away from using. Alternatively, the one or more actions may include the communication manager transmitting the one or more messages via the first communication and the second communication channel based on the transition score satisfying the transition threshold. This improves the likelihood that the user receives, opens, accesses, and/or otherwise interacts with the one or more messages via at least one of the first communication or the second communication channel.

As indicated above, FIGS. 1A-1C are provided as an example. Other examples may differ from what is described with regard to FIGS. 1A-1C.

FIG. 2 is a diagram illustrating an example 200 of training and using a machine learning model in connection with transition detection for communication channel switching. The machine learning model training and usage described herein may be performed using a machine learning system 205. The machine learning system 205 may include or may be included in a computing device, a server, a cloud computing environment, or the like, such as the communication manager described in more detail elsewhere herein. In some implementations, the machine learning system 205 may be, or may be included in, the AI/ML model 135.

As shown by reference number 210, a machine learning model may be trained using a set of observations. The set of observations may be obtained from training data (e.g., historical data), such as data gathered during one or more processes described herein. In some implementations, the machine learning system 205 may receive the set of observations (e.g., as input) from the user device or a server device associated with one or more communication channels, as described elsewhere herein.

As shown by reference number 215, the set of observations may include a feature set. The feature set may include a set of variables, and a variable may be referred to as a feature. A specific observation may include a set of variable values (or feature values) corresponding to the set of variables. In some implementations, the machine learning system 205 may determine variables for a set of observations and/or variable values for a specific observation based on input received from the user device or a server device associated with one or more communication channels. For example, the machine learning system 205 may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a tool utilization score (e.g., that is based on a utilization rate of the tool described in connection with FIGS. 1A-1B), a second feature of a click-through rate (e.g., of one or more messages transmitted via a communication channel), a third feature of a failure indication (e.g., indicating whether there has been a soft bounce or a hard bounce for the communication channel), and so on. As shown, for a first observation, the first feature may have a value of 85, the second feature may have a value of 5%, the third feature may have a value of “No”, and so on. These features and feature values are provided as examples, and may differ in other examples. For example, the feature set may include one or more of the following features: an open rate, a read rate, a deletion rate, a bounce rate, a response rate, a forward or share rate, an unsubscribe rate, a delivery rate, an engagement rate (e.g., based on a combination of interactions), and/or an amount of time spent interacting with a message, among other examples.

As shown by reference number 220, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is transition score, which has a value of 20 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 225, the machine learning system 205 may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system 205 may store the machine learning model as a trained machine learning model 230 to be used to analyze new observations.

As an example, the machine learning system 205 may obtain training data for the set of observations based on interaction information for a user and a given communication channel. For example, the training data may include historical interaction information for one or more previously transmitted messages associated with the user and the given communication channel (e.g., obtained from the user device or a server device). Additionally, or alternatively, the training data may include historical interaction information for one or more previously transmitted messages associated with one or more users who are known to have previously transitioned away from using a given communication channel.

As shown by reference number 235, the machine learning system 205 may apply the trained machine learning model 230 to a new observation, such as by receiving a new observation and inputting the new observation to the trained machine learning model 230. As shown, the new observation may include a first feature of tool utilization score, a second feature of click-through rate, a third feature of the failure indication, and so on, as an example. The machine learning system 205 may apply the trained machine learning model 230 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 230 may predict a value of 70 for the target variable of transition score for the new observation, as shown by reference number 240. Based on this prediction, the machine learning system 205 may provide a first recommendation, may provide output for determination of a first recommendation, may perform a first automated action, and/or may cause a first automated action to be performed (e.g., by instructing another device to perform the automated action), among other examples. The first recommendation may include, for example, transitioning the user to a second communication channel. The first automated action may include, for example, determining or selecting the second communication channel, and/or routing one or more messages to the second communication channel (e.g., that were originally intended for the first communication channel), among other examples.

As another example, if the machine learning system 205 were to predict a value of 10 for the target variable of transition score, then the machine learning system 205 may provide a second (e.g., different) recommendation (e.g., to maintain use of the first communication channel) and/or may perform or cause performance of a second (e.g., different) automated action (e.g., continue transmitting messages via the first communication channel).

In some implementations, the trained machine learning model 230 may classify (e.g., cluster) the new observation in a cluster, as shown by reference number 245. The observations within a cluster may have a threshold degree of similarity. As an example, if the machine learning system 205 classifies the new observation in a first cluster (e.g., likely transitioning from use of a communication channel), then the machine learning system 205 may provide a first recommendation, such as the first recommendation described above. Additionally, or alternatively, the machine learning system 205 may perform a first automated action and/or may cause a first automated action to be performed (e.g., by instructing another device to perform the automated action) based on classifying the new observation in the first cluster, such as the first automated action described above.

As another example, if the machine learning system 205 were to classify the new observation in a second cluster (e.g., not likely transitioning from use of a communication channel), then the machine learning system 205 may provide a second (e.g., different) recommendation (e.g., to maintain use of the first communication channel) and/or may perform or cause performance of a second (e.g., different) automated action, such as continuing to transmit messages via the first communication channel.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 230 may be re-trained using feedback information. For example, feedback may be provided to the machine learning model. The feedback may be associated with actions performed based on the recommendations provided by the trained machine learning model 230 and/or automated actions performed, or caused, by the trained machine learning model 230. In other words, the recommendations and/or actions output by the trained machine learning model 230 may be used as inputs to re-train the machine learning model (e.g., a feedback loop may be used to train and/or update the machine learning model). For example, the feedback information may include interaction information for messages transmitted via the second communication channel, and/or input from a representative indicating whether the user actually transitioned away from using the first communication channel, among other examples.

In this way, the machine learning system 205 may apply a rigorous and automated process to detect a transition for communication channel switching. The machine learning system 205 may enable recognition and/or identification of tens, hundreds, thousands, or millions of features and/or feature values for tens, hundreds, thousands, or millions of observations, thereby increasing accuracy and consistency and reducing delay associated with transition detection for communication channel switching relative to requiring computing resources to be allocated for tens, hundreds, or thousands of operators to manually detect a transition for communication channel switching using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a communication manager 310, a user device 320, a client device 330, and a network 340. Devices of environment 300 may interconnect via wired connections, wireless connections, or a combination of wired and wireless connections.

The communication manager 310 may include one or more devices capable of receiving, generating, storing, processing, providing, and/or routing information associated with transition detection for communication channel switching, as described elsewhere herein. The communication manager 310 may include a communication device and/or a computing device. For example, the communication manager 310 may include a server, such as an application server, a client server, a web server, a database server, a host server, a proxy server, a virtual server (e.g., executing on computing hardware), or a server in a cloud computing system. In some implementations, the communication manager 310 may include computing hardware used in a cloud computing environment, such as one or more serverless components (e.g., one or more serverless functions), among other examples.

The user device 320 may include one or more devices capable of receiving, generating, storing, processing, and/or providing information associated with transition detection for communication channel switching, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a wearable communication device (e.g., a smart wristwatch, a pair of smart eyeglasses, a head mounted display, or a virtual reality headset), or a similar type of device.

The client device 330 may include one or more devices capable of receiving, generating, storing, processing, and/or providing information associated with transition detection for communication channel switching, as described elsewhere herein. The client device 330 may include a communication device and/or a computing device. For example, the client device 330 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with transition detection for communication channel switching. The device 400 corresponds to one or more of the communication manager 310, the user device 320, and/or the client device 330. In some implementations, the communication manager 310, the user device 320, and/or the client device 330 include one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

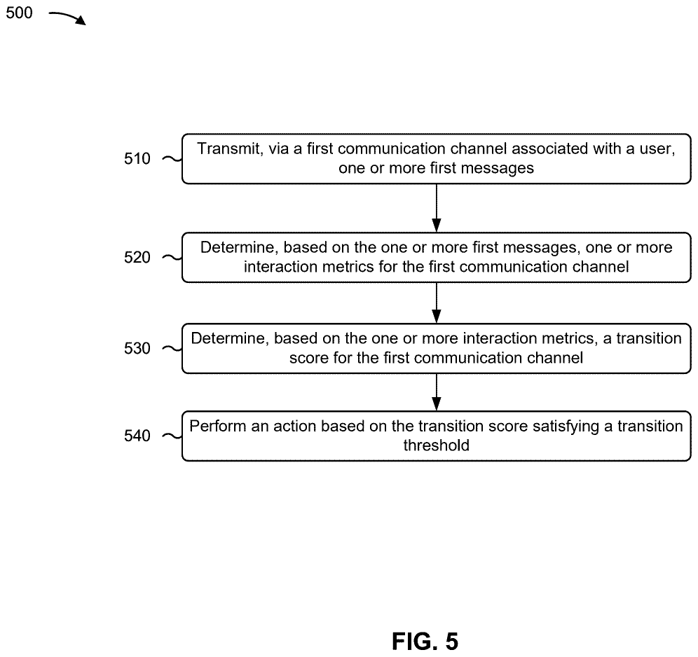

FIG. 5 is a flowchart of an example process 500 associated with transition detection for communication channel switching. In some implementations, one or more process blocks of FIG. 5 may be performed by the communication manager 310. In some implementations, one or more process blocks of FIG. 5 may be performed by another device or a group of devices separate from or including the communication manager 310, such as the user device 320, and/or the client device 330, among other examples. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include transmitting, via a first communication channel associated with a user, one or more first messages (block 510). For example, the communication manager 310 (e.g., using processor 420, memory 430, and/or communication component 460) may transmit, via a first communication channel associated with a user, one or more first messages, as described above in connection with reference number 105 of FIG. 1A. As an example, the first communication channel may be an email communication channel associated with a first email address or a first email account.

As further shown in FIG. 5, process 500 may include determining, based on the one or more first messages, one or more interaction metrics for the first communication channel (block 520). For example, the communication manager 310 (e.g., using processor 420 and/or memory 430) may determine, based on the one or more first messages, one or more interaction metrics for the first communication channel, as described above in connection with reference number 125 of FIG. 1A. As an example, the one or more interaction metrics may indicate an interaction level of a user with the one or more first messages and/or with a tool that is associated with the one or more first messages.

As further shown in FIG. 5, process 500 may include determining, based on the one or more interaction metrics, a transition score for the first communication channel (block 530). For example, the communication manager 310 (e.g., using processor 420 and/or memory 430) may determine, based on the one or more interaction metrics, a transition score for the first communication channel, as described above in connection with reference number 130 of FIG. 1A. In some implementations, the transition score is a predictive score that indicates a likelihood that the user will transition from use of the first communication channel. In some implementations, the communication manager 310 may determine the transition score using an AI/ML model (e.g., the AI/ML model 135 and/or the machine learning system 205).

As further shown in FIG. 5, process 500 may include performing an action based on the transition score satisfying a transition threshold (block 540). For example, the communication manager 310 (e.g., using processor 420 and/or memory 430) may perform an action based on the transition score satisfying a transition threshold, as described above in connection with reference number 150 of FIG. 1B. As an example, the action may include transitioning the user from the first communication channel to a second communication channel. For example, the communication manager 310 may route one or more second messages (e.g., intended for transmission via the first communication channel) to the second communication channel. For example, the second communication channel may be an email communication channel associated with a second email address or a second email account.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using an artificial intelligence or machine learning (AI/ML) model to detect transitions for communication channel switching, the system comprising:
one or more memories; and
one or more processors, communicatively coupled to the one or more memories, configured to:
transmit, via a first communication channel associated with a user, one or more first messages;
determine, based on the one or more first messages, one or more interaction metrics for the first communication channel;
determine, using the AI/ML model and based on the one or more interaction metrics, a transition score for the first communication channel, wherein the transition score is a predictive score that indicates a likelihood that the user will transition from use of the first communication channel;
obtain one or more second messages to be transmitted via the first communication channel;
route, based on the transition score satisfying a transition threshold, the one or more second messages to a second communication channel; and
transmit, based the one or more second messages being routed to the second communication channel, the one or more second messages via the second communication channel.

2. The system of claim 1, wherein the first communication channel is active when the one or more second messages are obtained.

3. The system of claim 1, wherein the one or more processors are further configured to:
determine, based on the transition score satisfying the transition threshold, the second communication channel based on the transition score.

4. The system of claim 1, wherein the one or more processors are further configured to:
refrain from transmission of messages for the user via the first communication channel based on the transition score satisfying the transition threshold.

5. The system of claim 1, wherein the one or more processors, to determine the transition score for the first communication channel, are configured to:
provide, to the AI/ML model, an input indicating the one or more interaction metrics; and
obtain, from the AI/ML model, an output indicating the transition score.

6. The system of claim 1, wherein the one or more interaction metrics include at least one of:
an open rate,
a click-through rate,
a response rate, or
a failure indication rate.

7. The system of claim 1, wherein the one or more first messages are associated with a tool, and wherein the one or more interaction metrics include a utilization rate, associated with the user, for the tool.

8. The system of claim 7, wherein the first communication channel is associated with an email account, wherein the email account is associated with an organization, wherein the tool is associated with the organization, and wherein the transition score indicates a likelihood that the user is transitioning away from an association with the organization.

9. The system of claim 1, wherein the transition score satisfying the transition threshold is based on a rate of change of the transition score satisfying a rate threshold.

10. The system of claim 1, wherein the one or more processors are further configured to:
transmit, via a third communication channel, a notification indicating that the user is transitioning from use of the first communication channel based on the transition score satisfying the transition threshold.

11. A method for transition detections for communication channel switching, comprising:
transmitting, by a device and via a first communication channel associated with a user, one or more first messages;
determining, by the device and based on the one or more first messages, one or more interaction metrics for the first communication channel;
determining, by the device and based on the one or more interaction metrics, a transition score for the first communication channel, wherein the transition score is a predictive score that indicates a likelihood that the user will transition from use of the first communication channel; and
performing, by the device, an action based on the transition score satisfying a transition threshold.

12. The method of claim 11, wherein performing the action comprises:
obtaining, by the device, one or more second messages to be transmitted via the first communication channel; and
transmitting, by the device, the one or more second messages via a second communication channel based on the transition score satisfying the transition threshold.

13. The method of claim 12, further comprising:
selecting the second communication channel based on a rate of change of the transition score.

14. The method of claim 11, wherein performing the action comprises:
refraining from transmitting messages for the user via the first communication channel based on the transition score satisfying the transition threshold.

15. The method of claim 11, wherein determining the transition score for the first communication channel comprises:
providing, to an artificial intelligence or machine learning (AI/ML) model, an input indicating the one or more interaction metrics; and
obtaining, from the AI/ML model, an output indicating the transition score.

16. The method of claim 11, wherein performing the action comprises:
transmitting a notification indicating that the user is transitioning from use of the first communication channel based on the transition score satisfying the transition threshold.

17. A non-transitory computer-readable medium storing a set of instructions, the set of instructions comprising:
one or more instructions that, when executed by one or more processors of a device, cause the device to:
transmit, via a first communication channel associated with a user, one or more first messages;
determine, using an artificial intelligence or machine learning (AI/ML) model and based on one or more interaction metrics for the first communication channel, a transition score for the first communication channel, wherein the transition score is a predictive score that indicates a likelihood that the user will transition from use of the first communication channel;
obtain one or more second messages to be transmitted via the first communication channel;
route, based on the transition score satisfying a transition threshold, the one or more second messages to a second communication channel; and
transmit, based the one or more second messages being routed to the second communication channel, the one or more second messages via the second communication channel.

18. The non-transitory computer-readable medium of claim 17, wherein the first communication channel is active when the one or more second messages are obtained.

19. The non-transitory computer-readable medium of claim 17, wherein the one or more instructions further cause the device to:
determine the second communication channel based on the transition score.

20. The non-transitory computer-readable medium of claim 17, wherein the transition score satisfying the transition threshold is based on a rate of change of the transition score satisfying a rate threshold.
